(19) United States
(12) Patent Application Publication
(10) Pub. No.: US 2026/0217034 A1
(43) Pub. Date: Jul. 30, 2026

(54) IMAGE RECORDING APPARATUS AND REPLACEMENT COMPONENT

(71) Applicant: BROTHER KOGYO KABUSHIKI KAISHA, Nagoya (JP)

(72) Inventors: Tetsunori MORI, Kariya (JP); Taichiro KIMOTO, Nagoya (JP)

(21) Appl. No.: 19/462,689

(22) Filed: Jan. 28, 2026

(30) Foreign Application Priority Data
Jan. 30, 2025 (JP) 2025-013959

(51) Int. Cl. B41J 2/175; G06F 21/44; G06K 15/00

(52) U.S. Cl. CPC B41J 2/17546; B41J 2/17566; G06F 21/44; G06K 15/407; G06K 15/4095; G06K 2215/101

(57) ABSTRACT

An image recording apparatus includes a replacement component having a storage section that stores authentication data, an image recording section, and a control section. The control section reads the authentication data from the storage section of the replacement component and executes an authentication process for the replacement component, permits image recording by the image recording section when the authentication process succeeds, and restricts image recording by the image recording section when the authentication process fails. The storage section includes a free area in which data can be read and written and a restricted area in which data writing is limited. Part of the authentication data is stored in the restricted area. Mirror data having the same content as the authentication data stored in the restricted area is stored in the free area.

### REFERENCE TO RELATED APPLICATIONS

This application claims priority from Japanese Patent Application No. 2025-013959 filed on January 30, 2025. The entire content of the priority application is incorporated herein by reference.

### TECHNICAL FIELD

The present disclosure relates to an image recording apparatus to which a replacement component is mounted.

### BACKGROUND ART

Printers in which a cartridge storing ink is mounted may perform an authentication process for the mounted cartridge. The authentication process is executed using communication between a control unit of the printer and an authentication IC of the mounted cartridge. When the authentication process succeeds, the control unit of the printer permits image recording. When the authentication process fails, the control unit of the printer prohibits image recording. The authentication process is executed at a timing when the printer is powered on or when the cartridge is replaced.

Regarding the present disclosure, one document discloses a printer that stores remaining ink amount data in two rewritable storage areas of a memory built into an ink cartridge. Another document discloses a printer that writes received print data to two hard disk drives and reads the print data from one of the hard disk drives.

### SUMMARY

In the authentication process, it is necessary to read multiple authentication data items from the memory of the authentication IC. The memory of the authentication IC has multiple areas with different specifications, and the authentication data is stored across multiple areas of the memory. Therefore, the control unit of the printer sequentially accesses multiple areas of the memory of the authentication IC. However, switching between the areas takes a certain amount of time, so the time required for the cartridge authentication process performed by the control unit of the printer tends to be longer.

The present disclosure is to provide a means for reducing the time required for authentication process of a replacement component in an image recording apparatus.

An image recording apparatus according to one aspect of the present disclosure may include a replacement component having a storage section that stores authentication data, an image recording section, and a control section. The control section reads the authentication data from the storage section of the replacement component and executes an authentication process for the replacement component. When the authentication process succeeds, the control section permits image recording by the image recording section, whereas when the authentication process fails, the control section restricts image recording by the image recording section.

The storage section includes a free area in which data can be read and written, and a restricted area in which data writing is limited. Part of the authentication data is stored in the restricted area, and mirror data is stored in the free area. The mirror data is the same as the authentication data stored in the restricted area.

According to the image recording apparatus described above, when executing the authentication process, the control section may access the mirror data stored in the free area instead of accessing the authentication data stored in the restricted area. Therefore, without taking longer time for accessing the restricted area, the authentication process of the replacement component can be completed in a short period.

### BRIEF DESCRIPTION OF DRAWINGS

FIG. 1A is an external perspective view of a printer 10, illustrating a state in which an ink cover 13 is closed.

FIG. 1B is an external perspective view of a printer 10, illustrating a state in which the ink cover 13 is open.

FIG. 2 is a cross-sectional view schematically showing the internal structure of the printer 10.

FIG. 3 is a block diagram of the printer 10.

FIG. 4 is a diagram showing data stored in a memory 72 of an ink cartridge 60.

FIG. 5 is a flowchart showing processing for the memory 72 when producing a new cartridge.

FIG. 6 is a flowchart showing processing for the memory 72 when producing a remanufactured cartridge.

FIG. 7 is a flowchart of a printing process.

FIG. 8 is a flowchart of a first authentication process.

FIG. 9 is a flowchart of a second authentication process.

### DESCRIPTION

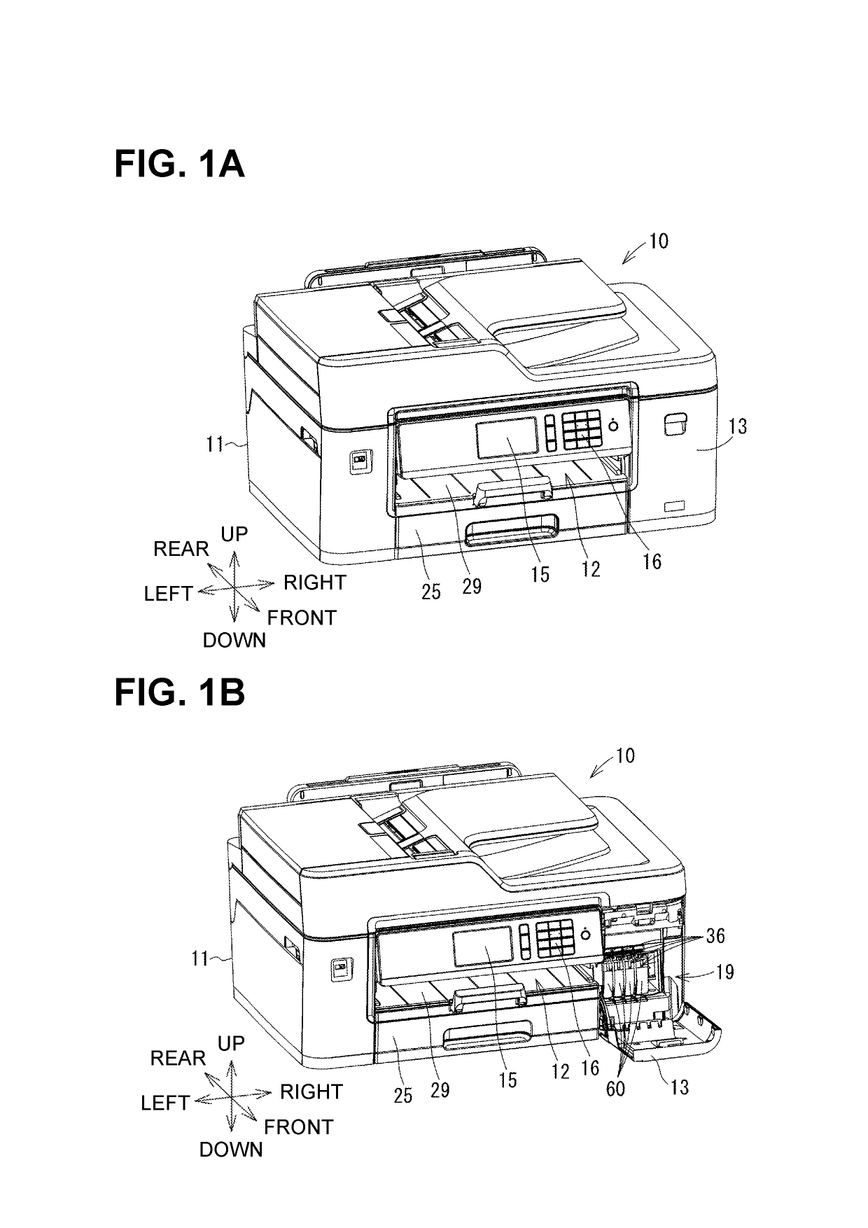

Hereinafter, embodiments will be described. It should be noted that the embodiments described below are merely examples, and the embodiments may be appropriately modified within a scope that does not alter the gist of the present invention. As shown in FIG. 1, the vertical direction is defined based on a state in which a printer 10 is installed for use on a horizontal surface. The front-rear direction is defined with a surface where an opening 19 of the printer 10 is located as the front, and the left-right direction is defined when viewing the printer 10 from the front. The vertical direction, front-rear direction, and left-right direction are mutually orthogonal.

[Overview of Printer 10] A printer 10 according to this embodiment is configured to record an image on a sheet by an inkjet recording method. The printer 10 includes a housing 11 having a substantially rectangular parallelepiped shape. The printer 10 may be a so-called multifunction peripheral having functions such as printing, facsimile, scanning, and copying.

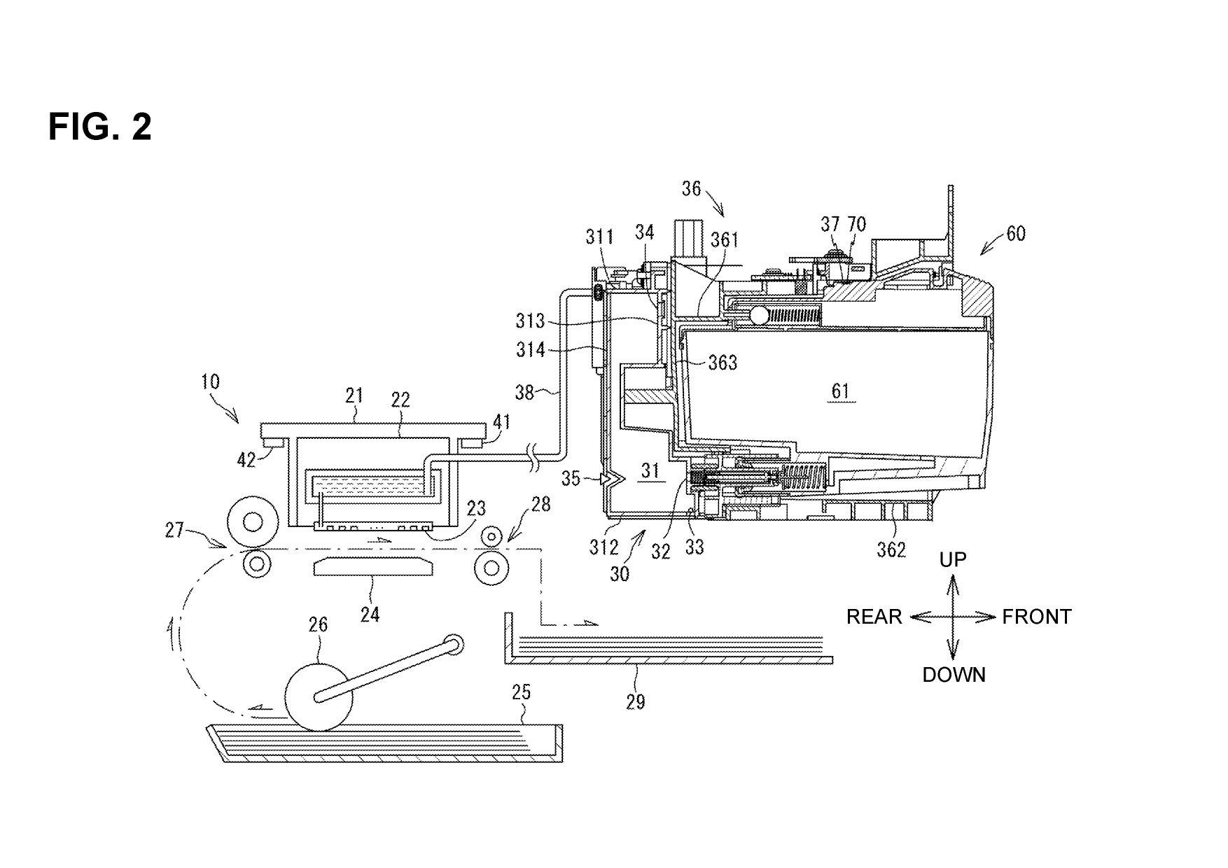

As shown in FIGS. 1 and 2, inside the housing 11 are located a carriage 21, a head 22, a platen 24, a feed tray 25, and a discharge tray 29. Inside the housing 11 are also located a feed roller 26, a transport roller 27, a discharge roller 28, a sub-tank 30, a remaining ink amount sensor 35, a mounting case 36, and a tube 38. The head 22 has a plurality of nozzles 23 for discharging ink. The platen 24 faces the head 22. The ink cartridge 60 is mounted in the mounting case 36.

A sheet on which an image is to be recorded is placed on the feed tray 25. The printer 10 drives the feed roller 26 and the transport roller 27 to transport the sheet to the platen 24. Next, the printer 10 causes ink supplied from the ink cartridge 60 to be discharged from the nozzles 23. As a result, the ink lands on the sheet supported on platen 24, and an image is recorded on the sheet. The printer 10 drives the discharge roller 28 to discharge the sheet on which the image has been recorded to the discharge tray 29.

The carriage 21 is supported by two guide rails 41 and 42 extending in the left-right direction and reciprocates in the left-right direction. The head 22 is mounted on the carriage 21. The printer 10 discharges ink from the nozzles 23 while moving the carriage 21 from left to right or from right to left. As a result, an image is recorded on a part of the region of the sheet facing the head 22.

Next, the printer 10 transports the sheet by the transport roller 27 so that the next region to be recorded faces the head 22. By alternately repeating these processes, an image is recorded on one sheet. The carriage 21, the head 22 having the nozzles 23, the platen 24, the feed roller 26, the transport roller 27, and the discharge roller 28 function as an image recording section.

[Ink Cartridge 60] As shown in FIG. 1(B), an opening 19 is located at the right end of the front surface of the housing 11. The housing 11 includes an ink cover 13 that covers the opening 19. The ink cover 13 is rotatably supported by the housing 11. The ink cover 13 is rotatable between a closed state shown in FIG. 1(A) and an open state shown in FIG. 1(B).

Four mounting cases 36 are located inside the opening 19. As shown in FIG. 2, each mounting case 36 includes an upper wall 361, a lower wall 362, a rear wall 363, and side walls (not shown). The ink cartridge 60 is inserted into and removed from the mounting case 36 through the opening 19. Each of the four mounting cases 36 is fitted with a respective ink cartridge 60 that stores black, magenta, cyan, or yellow ink.

As shown in FIG. 2, the ink cartridge 60 has a liquid chamber 61 for storing ink. The sub-tank 30 also has a liquid chamber 31 for storing ink. When the ink cartridge 60 is mounted in the mounting case 36, the liquid chamber 61 communicates with the liquid chamber 31, and ink in the liquid chamber 61 flows into the liquid chamber 31. The sub-tank 30 temporarily stores ink that has flowed into the liquid chamber 31. Ink stored in the sub-tank 30 is supplied to the head 22 via the tube 38.

The ink cartridge 60 includes an authentication IC 70 that stores data related to the ink cartridge 60. The authentication IC 70 is electrically connected to a contact (not shown) provided on the ink cartridge 60. The mounting case 36 has a contact 37. When the ink cartridge 60 is mounted in the mounting case 36, the contact on the ink cartridge 60 comes into contact with the contact 37 on the mounting case 36.

[Sub-Tank 30 and Remaining Ink Amount Sensor 35] The printer 10 includes four sub-tanks 30 each corresponding to a respective ink cartridge 60. Each sub-tank 30 is located behind the rear wall 363 of the mounting case 36. Each sub-tank 30 includes a liquid chamber 31, an inlet 32, an outlet 33, and an air vent 34. The liquid chamber 31 is surrounded by an upper wall 311, a lower wall 312, a front wall 313, a rear wall 314, and two side walls (not shown). The two side walls are connected to the upper wall 311, the lower wall 312, the front wall 313, and the rear wall 314.

The inlet 32 is located in the front wall 313. The outlet 33 is located in the lower wall 312. The air vent 34 is located in the front wall 313. At least part of the liquid chamber 31 is located below at least part of the liquid chamber 61 of the ink cartridge 60 while the ink cartridge 60 is mounted in the mounting case 36. The lower end of the liquid chamber 31 is located below the lower end of the liquid chamber 61 of the ink cartridge 60 while the ink cartridge 60 is mounted in mounting case 36.

Ink flows into the inlet 32 from the liquid chamber 61 of the ink cartridge 60 mounted in the mounting case 36. The liquid chamber 31 stores ink that has flowed in through the inlet 32. Ink stored in the liquid chamber 31 flows out through the outlet 33 toward the head 22 via the tube 38. The air vent 34 communicates the liquid chamber 31 with the atmosphere.

As shown in FIG. 2, the remaining ink amount sensor 35 is located on the rear wall 314 of each sub-tank 30. The remaining ink amount sensor 35 is positioned at the same vertical position as the center of the inlet 32. The remaining ink amount sensor 35 includes a light-emitting element and a light-receiving element disposed opposite each other across the two sidewalls of the sub-tank 30. For example, the light-emitting element is located to the left of a left sidewall of the sub-tank 30, and the light-receiving element is located to the right of a right sidewall of the sub-tank 30. A part of the two sidewalls of the sub-tank 30 allows light to pass through. For example, the part of the two sidewalls is made of transparent or translucent material. Alternatively, the entire sidewall may be made of transparent or translucent material.

When the liquid level of ink stored in the sub-tank 30 is below the position of the remaining ink amount sensor 35, light emitted from the light-emitting element enters the light-receiving element through the part of the sidewalls. In this case, the remaining ink amount sensor 35 outputs, for example, a high-level signal. When the liquid level of ink stored in the sub-tank 30 is above the position of the remaining ink amount sensor 35, light emitted from the light-emitting element is scattered by the ink stored in the sub-tank 30. Therefore, the amount of light entering the light-receiving element is low. In this case, the remaining ink amount sensor 35 outputs, for example, a low-level signal.

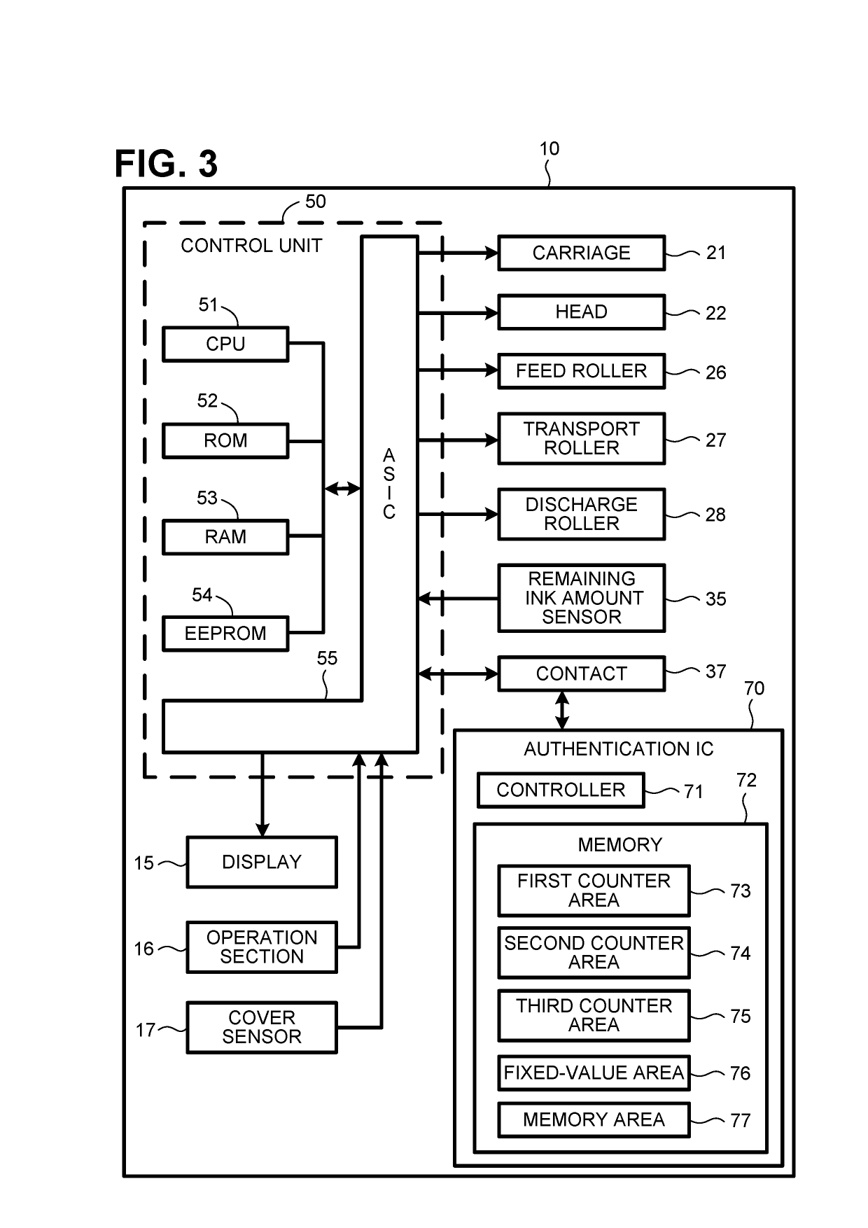

In the above description, the remaining ink amount sensor 35 is assumed to be an optical sensor, but another configuration of the remaining ink amount sensor 35 may be allowed. The remaining ink amount sensor 35 may be a float-type sensor or an electrode-type sensor.

[Control Unit 50] The control unit 50, shown in FIG. 3, is located inside the housing 11. The control unit 50 includes a CPU 51, a ROM 52, a RAM 53, an EEPROM 54, and an ASIC 55. The ROM 52 stores programs for the CPU 51 to execute various processes. The RAM 53 records data used by the CPU 51 when executing various processes. The EEPROM 54 stores data that should be retained even after power-off.

The carriage 21, the head 22, the feed roller 26, the transport roller 27, and discharge roller 28 are electrically drivable by the ASIC 55. The control unit 50 drives motors (not shown) via the ASIC 55. This allows the control unit 50 to move the carriage 21 in the left-right direction and rotate the feed roller 26, the transport roller 27, and the discharge roller 28. The control unit 50 outputs drive signals to drive elements of the head 22 via the ASIC 55, thereby causing ink to be ejected from the nozzles 23 of the head 22. The ASIC 55 outputs multiple types of drive signals according to the amount of ink to be discharged from the nozzles 23.

The remaining ink amount sensor 35 is electrically connected to the ASIC 55. The remaining ink amount sensor 35 outputs a low-level signal when the amount of ink stored in the sub-tank 30 is equal to or greater than a threshold. The remaining ink amount sensor 35 outputs a high-level signal when the amount of ink is less than the threshold.

The contact 37 is electrically connected to the ASIC 55. When the ink cartridge 60 is mounted in the mounting case 36, the contact 37 comes into contact with the contact on the ink cartridge 60. The control unit 50 accesses the authentication IC 70 of the ink cartridge 60 via the contact 37 and the contact on the ink cartridge 60. This allows the control unit 50 to read data from the authentication IC 70 and write data to the authentication IC 70.

A display 15, an operation section 16, and a cover sensor 17 are electrically connected to the ASIC 55. The display 15 displays characters and graphics within a display area as instructed by the control unit 50. The display 15 may be a liquid crystal display or an organic EL display. The operation section 16 outputs signals corresponding to user operations to the control unit 50. The operation section 16 may include physical switches, or a touch sensor overlaid on the display 15.

The cover sensor 17 is located near the ink cover 13 in the housing 11. The cover sensor 17 outputs a signal to the control unit 50 indicating whether the ink cover 13 is open or closed.

[Authentication IC 70] As shown in FIG. 3, the authentication IC 70 includes a controller 71 and a nonvolatile memory 72. The memory 72 includes a free area in which data can be read and written and a restricted area in which data writing is limited. Specifically, the memory 72 includes a first counter area 73, a second counter area 74, a third counter area 75, a fixed-value area 76, and a memory area 77. Among these, the memory area 77 is the free area, and the remaining four areas are restricted areas.

Among the restricted areas, the first counter area 73, the second counter area 74 and the third counter area 75 are for increment only or decrement only of stored data. The first counter area 73 is a counter area for increment only. The second counter area 74 is a counter area for increment only. The third counter area 75 is a counter area for decrement only. The fixed-value area 76 is a read-only area in which stored data cannot be updated.

The memory 72 may be specifically configured so that each of the counter areas 73, 74 and 75 possesses its respective characteristics. Alternatively, the memory 72 may be a readable and writable memory, and the controller 71 may restrict access to each of the counter areas 73, 74 and 75. In the latter configuration, the controller 71 may prohibit writing data to the fixed-value area 76. The controller 71 may prohibit any access other than decrement of data stored in the first counter area 73 and the third counter area 75. The controller 71 may prohibit any access other than increment of data stored in the second counter area 74.

[Authentication Process of Ink Cartridge 60 and Authentication Data] The CPU 51 of the control unit 50 performs an authentication process for the ink cartridge 60 by communicating with the controller 71 of the authentication IC 70. The authentication process is for determining whether to permit or restrict image recording by the image recording section of the printer 10. The CPU 51 communicates with the controller 71 using, for example, 1-Wire® communication method. However, the CPU 51 may communicate with the controller 71 using another communication method.

The memory 72 of the authentication IC 70 stores authentication data, which is data for the control unit 50 to execute the authentication process for the ink cartridge 60. The CPU 51 obtains the authentication data stored in the memory 72 of the authentication IC 70 by communicating with the controller 71. The CPU 51 performs the authentication process for the ink cartridge 60 based on the obtained authentication data.

In the following description, the authentication data is assumed to include remaining ink amount, remanufacture count, remaining authentication count, serial number, and used flag. The remaining ink amount indicates the amount of ink stored in the liquid chamber 61 of the ink cartridge 60. The remanufacture count indicates the number of times the ink cartridge 60 has been remanufactured. Remanufacture refers to a process in which, after the ink stored in the liquid chamber 61 is depleted, the liquid chamber 61 is filled with new ink to make the ink cartridge 60 usable again.

The remaining authentication count indicates the remaining number of times authentication of the ink cartridge 60 can be executed. The remaining authentication count is set to an initial value at the time of manufacture of the ink cartridge 60 and is decremented by one each time authentication is executed. The ink cartridge 60 with a remaining authentication count of zero cannot be used in the printer 10. The serial number is a fixed number assigned to identify the authentication IC 70. The serial number also serves as an identifier of the ink cartridge 60.

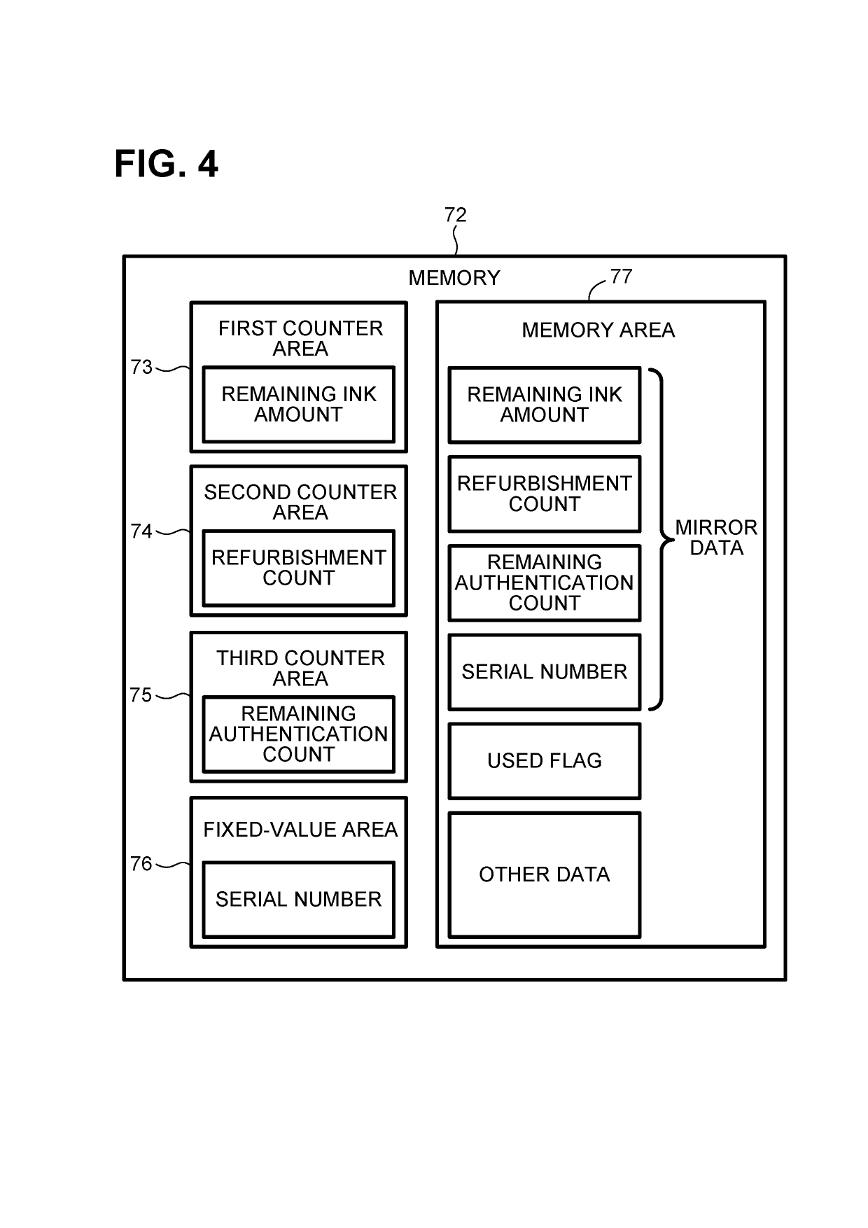

The used flag indicates whether the ink cartridge 60 has been used. The used flag is set to unused at the time of manufacture and remanufacture of the ink cartridge 60. The used flag is set to used when the ink cartridge 60 is first used after manufacture or remanufacture.

[Memory 72 of Authentication IC 70] As shown in FIG. 4, the authentication data is stored across multiple areas of the memory 72 of the authentication IC 70. Specifically, the remaining ink amount is stored in the first counter area 73. The remanufacture count is stored in the second counter area 74. The remaining authentication count is stored in the third counter area 75. The serial number is stored in the fixed-value area 76. The used flag is stored in the memory area 77. Thus, part of the authentication data is stored in restricted areas, i.e., the first counter area 73, the second counter area 74, the third counter area 75, and the fixed-value area 76.

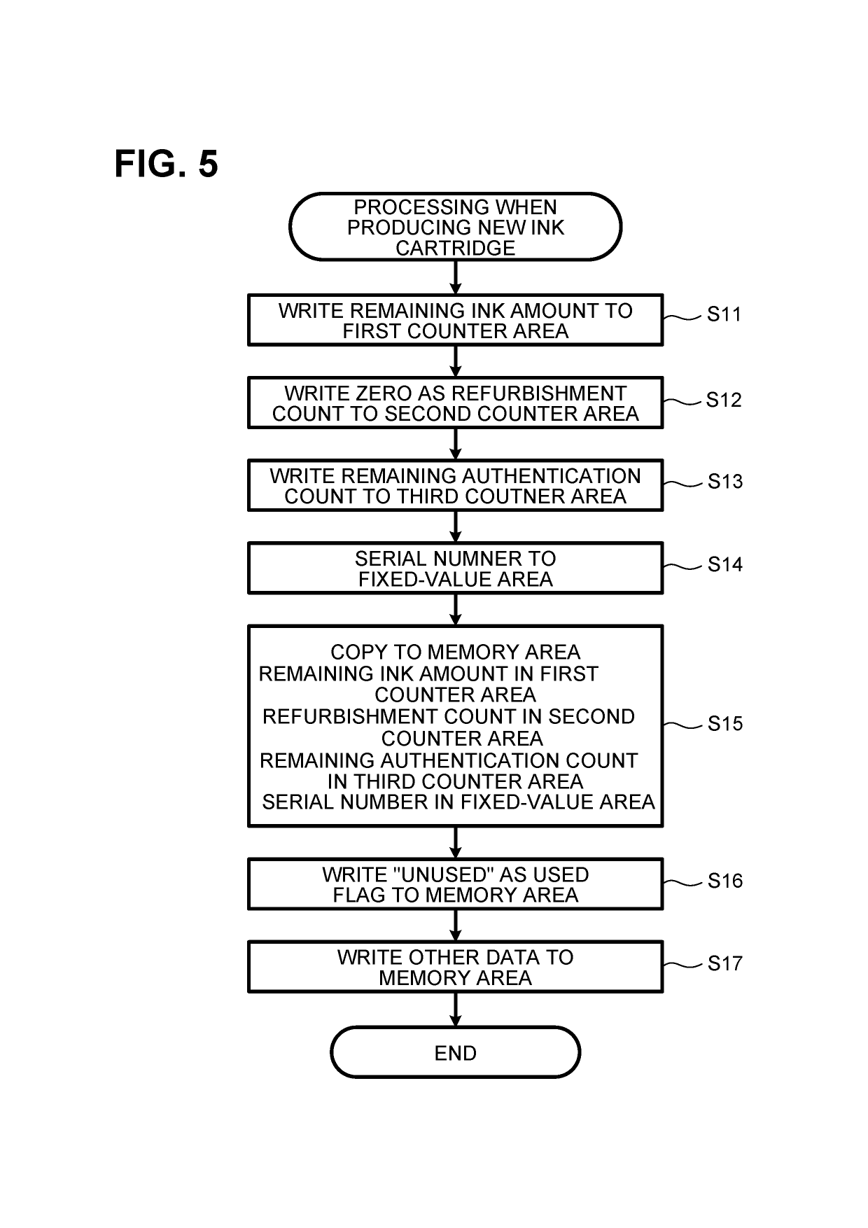

The memory area 77 stores mirror data, having the same content as the authentication data. The memory area 77 stores mirror data of the remaining ink amount stored in the first counter area 73, mirror data of the remanufacture count stored in the second counter area 74, mirror data of the remaining authentication count stored in the third counter area 75, and mirror data of the serial number stored in the fixed-value area 76. In addition, the memory area 77 stores other data besides the authentication data.

[Processing When Producing New Ink Cartridge] When producing a new ink cartridge 60, a memory writing device is used to write authentication data to the memory 72 of the authentication IC 70. The ink cartridge 60 is mounted on the memory writing device. The memory writing device executes processing shown in FIG. 5 for the memory 72 of the authentication IC 70 on the mounted ink cartridge 60.

First, in step S11, the memory writing device writes the remaining ink amount to the first counter area 73. The remaining ink amount written in step S11 is the amount of ink stored in the liquid chamber 61 of the new ink cartridge 60. Next, in step S12, the memory writing device writes a value of zero as the remanufacture count to the second counter area 74.

Next, in step S13, the memory writing device writes the remaining authentication count to the third counter area 75. The remaining authentication count written in step S13 is a predetermined number. Next, in step S14, the memory writing device writes the serial number to the fixed-value area 76. The serial number may be stored in the fixed-value area 76 in advance when manufacturing the authentication IC 70.

Next, in step S15, the memory writing device copies the following four data items to the memory area 77: (1) the remaining ink amount stored in the first counter area 73; (2) the remanufacture count stored in the second counter area 74; (3) the remaining authentication count stored in the third counter area 75; and (4) the serial number stored in the fixed-value area 76.

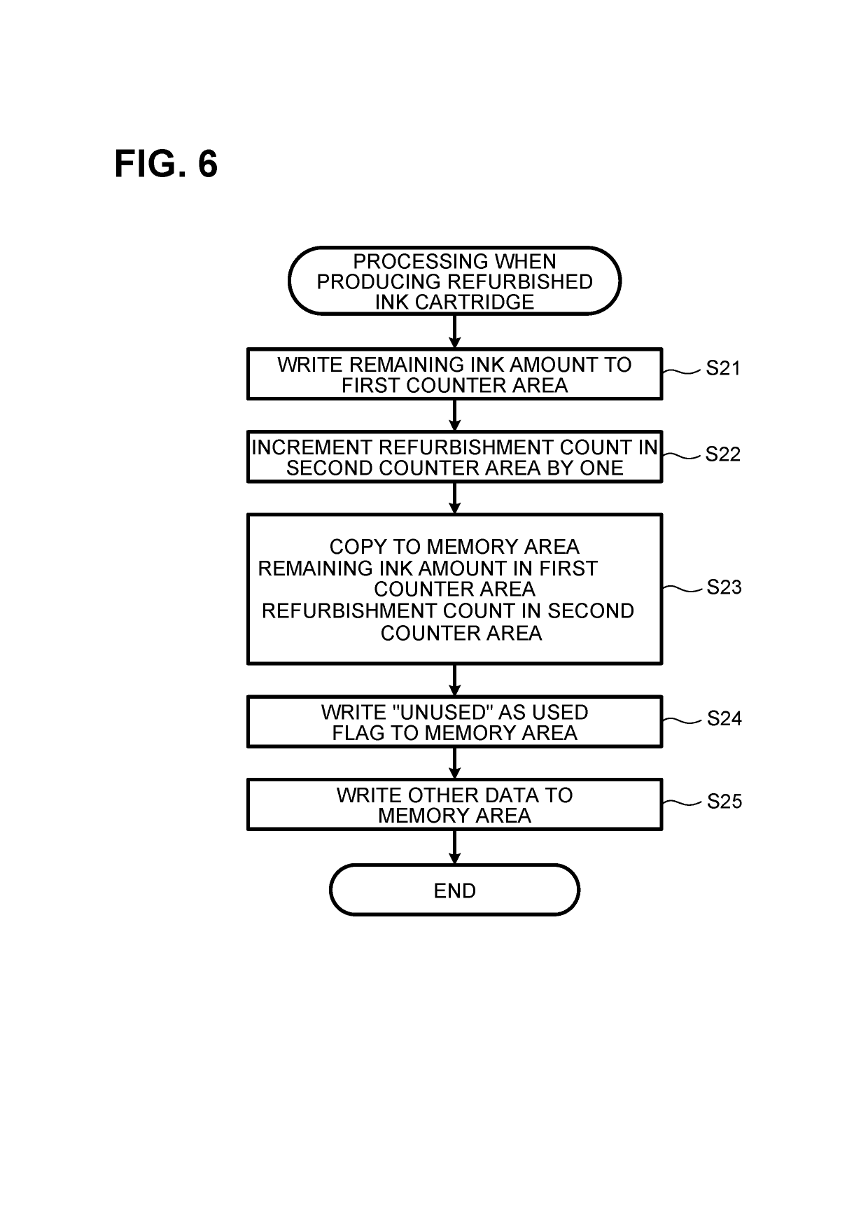

Next, in step S16, the memory writing device sets the used flag to “unused” in the memory area 77. Then, in step S17, the memory writing device writes other data, which is not authentication data, to the memory area 77. After the memory writing device completes the processing shown in FIG. 5, the memory 72 assumes the state shown in FIG. 4.

[Processing When Producing Remanufactured Ink Cartridge] When producing a remanufactured ink cartridge 60, i.e., when refurbishing a depleted ink cartridge, the memory writing device is also used to update the authentication data stored in the memory 72 of the authentication IC 70 on the remanufactured ink cartridge. The memory writing device executes processing shown in FIG. 6 for the memory 72 of the authentication IC 70 on the mounted ink cartridge 60.

First, in step S21, the memory writing device writes the remaining ink amount to the first counter area 73. The remaining ink amount written in step S21 is the amount of ink stored in the liquid chamber 61 of the remanufactured ink cartridge 60. Next, in step S22, the memory writing device increments by one the remanufacture count stored in the second counter area 74.

Next, in step S23, the memory writing device copies the following two data items to the memory area 77: (1) the remaining ink amount stored in the first counter area 73; and (2) the remanufacture count stored in the second counter area 74.

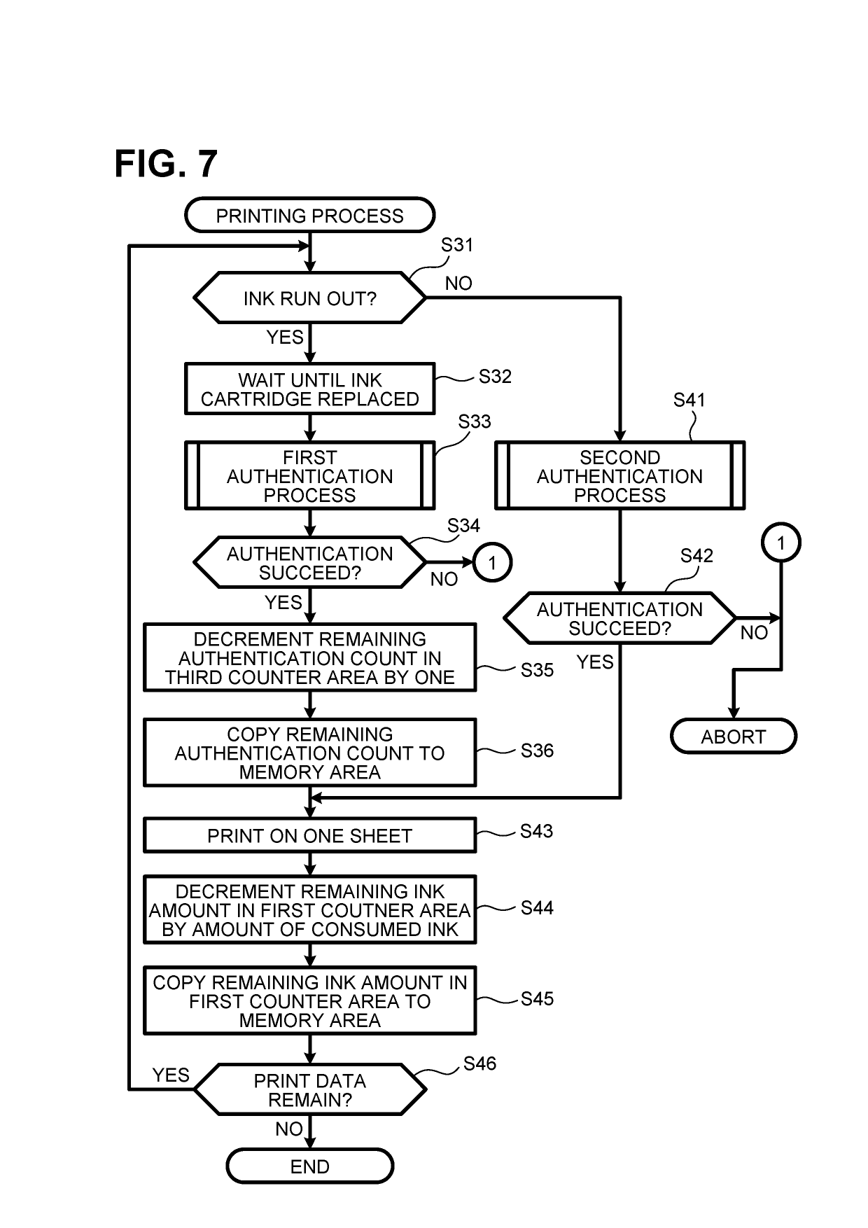

Next, in step S24, the memory writing device sets the used flag to “unused” in the memory area 77. Then, in step S25, the memory writing device writes other data, which is not authentication data, to the memory area 77. By completing the processing shown in FIG. 6, the data stored in the memory 72 is correctly updated.

[Printing Process] The control unit 50 executes printing process shown in FIG. 7 when a print instruction is input using the operation section 16. The control unit 50 executes the printing process shown in FIG. 7 by the CPU 51 executing a program stored in the ROM 52. The program executed by the CPU 51 may also be stored in the EEPROM 54.

At the beginning of the printing process, the control unit 50 proceeds processing to step S31. In step S31, the control unit 50 determines whether any of the four ink cartridges 60 is out of ink. The control unit 50 determines whether ink has run out based on the amount of ink consumed after output signal of the remaining ink amount sensor 35 changes from low level to high level. If the control unit 50 determines that any of the four ink cartridges 60 is out of ink, the control unit 50 proceeds processing to step S32.

In this case, in step S32, the control unit 50 waits until the ink cartridge 60 determined to be out of ink is replaced. The control unit 50 determines whether the ink cartridge 60 has been replaced based on output signal of the cover sensor 17 and the output signal of the remaining ink amount sensor 35. After determining that the ink cartridge 60 determined to be out of ink has been replaced, the control unit 50 proceeds processing to step S33.

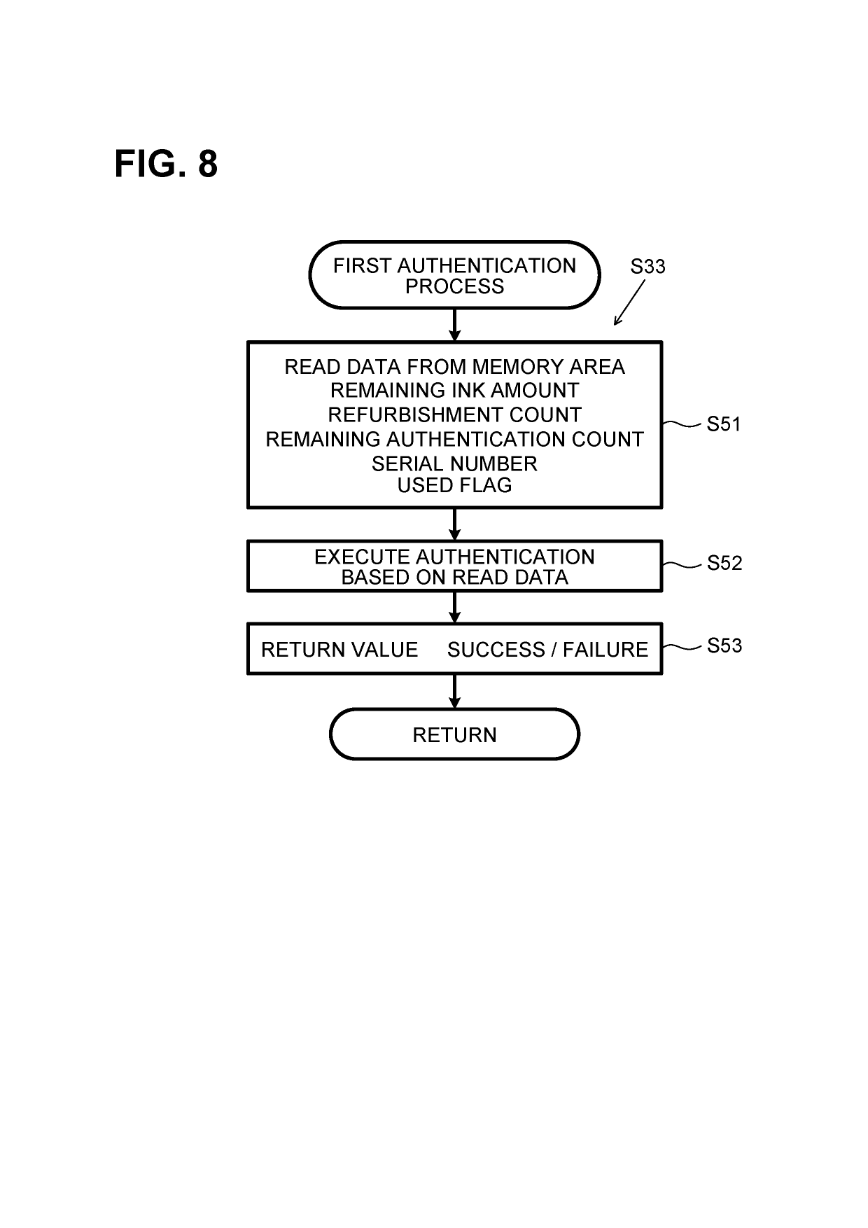

Next, in step S33, the control unit 50 executes first authentication process shown in FIG. 8 for the replaced ink cartridge 60. Then, in step S34, the control unit 50 determines whether authentication has succeeded. If the control unit 50 determines that authentication has succeeded, the control unit 50 proceeds processing to step S35. If the control unit 50 determines that authentication has not succeeded, i.e., has failed, the control unit 50 aborts the printing process.

If the authentication has succeeded, in step S35, the control unit 50 decrements by one the remaining authentication count stored in the third counter area 75 for the replaced ink cartridge 60. Next, in step S36, the control unit 50 copies the remaining authentication count stored in the third counter area 75 to the memory area 77 for the replaced ink cartridge 60. Then, the control unit 50 proceeds processing to step S41.

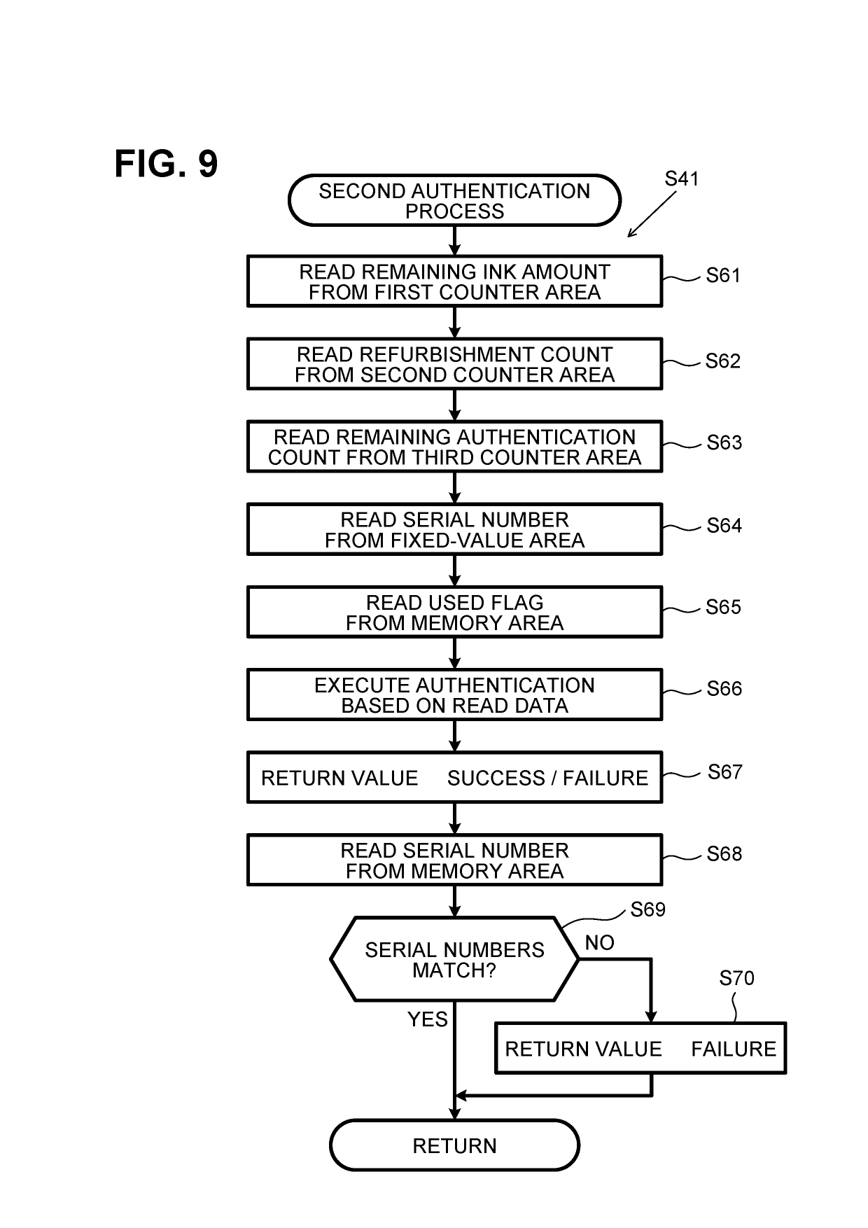

The control unit 50 proceeds processing to step S41 when determined in step S31 that none of the ink cartridges 60 is out of ink. In this case, in step S41, the control unit 50 executes second authentication process shown in FIG. 9 for each of the four ink cartridges 60. Next, in step S42, the control unit 50 determines whether authentication has succeeded for all four ink cartridges 60. If the control unit 50 determines that authentication has succeeded for all four ink cartridges 60, the control unit 50 proceeds processing to step S43. If the control unit 50 determines that authentication has not succeeded, i.e., has failed, for any of the four ink cartridges 60, the control unit 50 aborts the printing process.

The control unit 50 proceeds processing to step S43 after executing step S36 or when determined in step S42 that authentication has succeeded. Next, in step S43, the control unit 50 performs printing on one sheet. In step S43, the control unit 50 controls the carriage 21, the head 22, the feed tray 25, the feed roller 26, and the transport roller 27 to record an image on the sheet.

Next, in step S44, the control unit 50 decrements the remaining ink amount stored in the first counter area 73 for each ink cartridge 60 by the amount of ink consumed during printing in step S43. Then, in step S45, the control unit 50 copies the remaining ink amount stored in the first counter area 73 to the memory area 77 for each ink cartridge 60.

Next, in step S46, the control unit 50 determines whether print data remains. If the control unit 50 determines that print data remains, the control unit 50 proceeds processing to step S31. If the control unit 50 determines that no print data remains, the control unit 50 ends the printing process.

Thus, the control unit 50 permits image recording by the image recording section when authentication succeeds, whereas the control unit 50 prohibits image recording, e.g., aborts print processing, by the image recording section when authentication fails.

[First Authentication Process] In step S33, the control unit 50 executes first authentication process shown in FIG. 8 for the replaced ink cartridge 60. At the beginning of the first authentication process, the control unit 50 proceeds processing to step S51. Next, in step S51, the control unit 50 reads five data items from the memory area 77 of the memory 72. The data items read in step S51 are remaining ink amount, remanufacture count, remaining authentication count, serial number, and used flag.

Next, in step S52, the control unit 50 performs authentication of the ink cartridge 60 based on the five data items read in step S51. In step S52, the control unit 50 performs a predetermined calculation on the five data items read. The control unit 50 executes authentication based on whether the calculation result matches an expected value. The authentication result is either “success” or “failure.”

Next, in step S53, the control unit 50 returns the authentication result of step S52 as a return value. Then, the control unit 50 ends the first authentication process and returns.

[Second Authentication Process] In step S41, the control unit 50 executes second authentication process shown in FIG. 9 for each of the four ink cartridges 60. At the beginning of the second authentication process, the control unit 50 proceeds processing to step S61.

In step S61, the control unit 50 reads the remaining ink amount from the first counter area 73. Next, in step S62, the control unit 50 reads the remanufacture count from the second counter area 74. Next, in step S63, the control unit 50 reads the remaining authentication count from the third counter area 75. Next, in step S64, the control unit 50 reads the serial number from the fixed-value area 76. Next, in step S65, the control unit 50 reads the used flag from memory area 77.

Next, in step S66, the control unit 50 performs authentication of ink cartridge based on the five data items read in steps S61 to S65. In step S66, the control unit 50 performs the same processing as in step S51. Then, in step S67, the control unit 50 returns the authentication result of step S66 as a return value.

Next, in step S68, the control unit 50 also reads the serial number from the memory area 77. Then, in step S69, the control unit 50 determines whether the serial number read from the fixed-value area 76 matches the serial number read from the memory area 77.

If the control unit 50 determines that the two serial numbers do not match, the control unit 50 proceeds processing to step S70. In this case, in step S70, the control unit 50 sets “failure” as the return value. Then, the control unit 50 ends the second authentication process and returns. If the control unit 50 determines in step S69 that the two serial numbers match, the control unit 50 ends the second authentication process and returns without executing step S70.

In the above description, the printer 10 is an example of an image recording apparatus. The ink cartridge 60 is an example of a replacement component. The mounting case 36 is an example of a mounting section. The carriage 21, the head 22 having nozzles 23, the platen 24, the feed roller 26, the transport roller 27, and the discharge roller 28 are examples of an image recording section.

The memory 72 is an example of a storage section. The first counter area 73, the second counter area 74, the third counter area 75, and the fixed-value area 76 are examples of restricted areas. The first counter area 73, the second counter area 74, and the third counter area 75 are examples of counter areas. The fixed-value area 76 is an example of a read-only area. The memory area 77 is an example of a free area.

Ink is an example of a consumable. The remaining ink amount is an example of the remaining amount of a consumable stored in the replacement component. The serial number is an example of an identifier of the replacement component.

Printing is an example of image recording. Prohibiting printing and aborting printing are examples of restricting image recording. The first authentication process and the second authentication process are examples of authentication processes. The first authentication process is an example of an authentication process executed when a replacement component is replaced. The second authentication process is an example of an authentication process executed during image recording by the image recording section.

As described above, a printer 10 according to this embodiment includes an ink cartridge 60 having a memory 72, an image recording section, and a control unit 50. The control unit 50 reads authentication data from the memory 72 and executes an authentication process for the ink cartridge 60. The control unit 50 permits printing by the image recording section when authentication succeeds, whereas the control unit 50 prohibits printing by the image recording section when authentication fails.

The memory 72 includes a memory area 77 as a free area in which data can be read and written. The memory 72 includes a first counter area 73, a second counter area 74, and a third counter area 75 and a fixed-value area 76 as restricted areas in which data writing is limited. Part of the authentication data is stored in the restricted areas, and mirror data having the same content as the authentication data stored in the restricted areas is stored in the free area. Part of the authentication data stored in the restricted areas includes remaining ink amount, remanufacture count, remaining authentication count, and serial number.

According to the printer 10 of this embodiment, the control unit 50 accesses mirror data in the free area instead of accessing authentication data in the restricted areas when executing the authentication process. The mirror data is data stored in the free area. Therefore, without taking longer time for accessing the restricted areas, the authentication process of ink cartridge 60 can be completed in a short period.

In the first authentication process, the control unit 50 reads mirror data from the free area and executes the authentication process. The control unit 50 accesses the mirror data stored in the free area when executing the authentication process. Therefore, without taking longer time for accessing the restricted area, the authentication process of ink cartridge 60 can be completed in a short period.

The restricted area includes a fixed-value area 76 as a read-only area, and the serial number, which is authentication data, is stored in the fixed-value area 76. Therefore, unauthorized rewriting of authentication data can be prevented.

In step S64, the control unit 50 reads the serial number from the fixed-value area 76, and in step S68, the control unit 50 reads the mirror data of the serial number from the memory area 77. The serial number read from the memory area 77 corresponds to the authentication data read from the fixed-value area 76. In steps S69 and S70, the control unit 50 determines that the authentication process has failed when the two serial numbers do not match. Therefore, the control unit 50 prohibits printing by the image recording section when the mirror data stored in the memory area 77 of the ink cartridge 60 has been tampered with.

The authentication data stored in the fixed-value area 76 includes the serial number. The serial number is an identifier of the ink cartridge 60. Therefore, the control unit 50 can execute the authentication process for the ink cartridge 60 based on the serial number.

The restricted area includes a first counter area 73, a second counter area 74, and a third counter area 75 as counter areas. The remaining ink amount, remanufacture count, and remaining authentication count, which are authentication data, are stored in the counter areas. Therefore, unauthorized rewriting of authentication data can be prevented.

In step S35, the control unit 50 updates the remaining authentication count stored in the third counter area 75. In step S36, the control unit 50 updates the remaining authentication count stored in the memory area 77. In step S44, the control unit 50 updates the remaining ink amount stored in the first counter area 73. In step S45, the control unit 50 updates the remaining ink amount stored in the memory area 77. Thus, the control unit 50 updates the mirror data stored in the free area corresponding to the authentication data stored in the counter areas when updating the authentication data stored in the counter areas. Therefore, the control unit 50 maintains a state in which the authentication data stored in the counter areas and the mirror data stored in the free area match.

The remaining ink amount stored in the first counter area 73 is the amount of ink stored in the liquid chamber 61. Thus, the authentication data stored in the counter areas includes the remaining amount of ink stored in the ink cartridge 60. Therefore, the control unit 50 can execute the authentication process for ink the cartridge 60 based on the remaining amount of ink stored in the ink cartridge 60.

In steps S44 and S45, the control unit 50 updates two remaining ink amounts each time printing by the image recording section for one sheet is completed. The first remaining ink amount is included in the authentication data stored in the first counter area 73. The second remaining ink amount is included in the mirror data stored in the memory area 77 corresponding to the remaining ink amount stored in the first counter area 73.

Therefore, the control unit 50 can maintain a state in which the remaining ink amount stored in the restricted area and the remaining ink amount stored in the free area match. The control unit 50 can also execute the authentication process for the ink cartridge 60 based on the remaining ink amount stored in either the restricted area or the free area.

When the ink cartridge 60 is replaced, the control unit 50 performs the first authentication process. When printing by the image recording section is performed, the control unit 50 performs the second authentication process. Thus, the control unit 50 executes different authentication processes when the ink cartridge 60 is replaced and when printing by the image recording section is performed. Therefore, the control unit 50 can vary the required time between the authentication process executed when the ink cartridge 60 is replaced and the authentication process executed during printing by the image recording section.

The printer 10 according to this embodiment includes a mounting case 36 in which the ink cartridge 60 is mounted, instead of the ink cartridge 60 itself. The operation of the control unit 50 and the configuration of the memory 72 are as described above.

The ink cartridge 60 according to this embodiment is a replacement component for the printer 10, which includes an image recording section and the control unit 50. The ink cartridge 60 includes a memory 72 that stores authentication data to be read by the control unit 50. The authentication data is data for the control unit 50 to execute an authentication process to determine whether to permit or prohibit printing by the image recording section. The configuration of the memory 72 is as described above.

[Modifications] Various modifications can be made to the printer 10 and the ink cartridge 60 according to this embodiment. For example, a memory 72 of the ink cartridge 60 in a modification does not necessarily include all five areas, i.e., a first counter area 73, a second counter area 74, a third counter area 75, a fixed-value area 76, and a memory area 77 and may include areas other than the five areas. The authentication data does not necessarily include all of remaining ink amount, remanufacture count, remaining authentication count, serial number, and used flag. The authentication data may include data other than these.

In a modification, the control unit 50 may perform authentication in any procedure based on mirror data read from the memory area 77 in step S52. The control unit 50 may also perform authentication in any procedure based on data read from areas, i.e., a first counter area 73, a second counter area 74, a third counter area 75, a fixed-value area 76, and a memory area 77 in step S66. In the second authentication process, the control unit 50 may read data from each area in an order different from that shown in FIG. 9. The memory writing device may write data to each area in an order different from that shown in FIGS. 5 and 6 when producing the ink cartridge.

Although the printer 10 records an image on a sheet by ejecting ink, a modification may record an image on a sheet with toner. In this case, the printer according to the modification mounts a toner cartridge storing toner as a replacement component. The replacement component is not limited to a cartridge storing a consumable. In a modification, the replacement component may be a waste liquid tank that stores waste liquid discharged from the image recording section.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image recording apparatus comprising:
a replacement component having a storage section that stores authentication data;
an image recording section; and
a control section, wherein
the control section reads the authentication data from the storage section of the replacement component and executes an authentication process for the replacement component, permits image recording by the image recording section when the authentication process succeeds, and restricts image recording by the image recording section when the authentication process fails,
the storage section includes a free area and a restricted area,
part of the authentication data is stored in the restricted area, and
mirror data having the same content as the authentication data in the restricted area is stored in the free area.

2. The image recording apparatus according to claim 1, wherein the control section executes the authentication process by reading the mirror data from the free area.

3. The image recording apparatus according to claim 2, wherein the restricted area includes a read-only area, and the authentication data is stored in the read-only area.

4. The image recording apparatus according to claim 3, wherein the control section determines that the authentication process has failed when the authentication data read from the read-only area does not match the mirror data read from the free area.

5. The image recording apparatus according to claim 3, wherein the authentication data stored in the read-only area includes an identifier of the replacement component.

6. The image recording apparatus according to claim 2, wherein
the restricted area includes a counter area for increment only or decrement only of stored data, and
the authentication data is stored in the counter area.

7. The image recording apparatus according to claim 6, wherein the control section updates the mirror data stored in the free area in response to updating the authentication data stored in the counter area.

8. The image recording apparatus according to claim 6, wherein the authentication data stored in the counter area includes a remaining amount of a consumable stored in the replacement component.

9. The image recording apparatus according to claim 8, wherein
the control section updates a first remaining among and a second remaining amount each time image recording by the image recording section for one sheet is completed,
the first remaining amount is a remaining amount of the consumable in the authentication data stored in the counter area, and
the second remaining amount is a remaining amount of the consumable in the mirror data stored in the free area.

10. The image recording apparatus according to claim 1, wherein an authentication process executed when the replacement component is replaced is different from an authentication process executed when image recording by the image recording section is performed.

11. An image recording apparatus comprising:
a mounting section for receiving a replacement component having a storage section that stores authentication data;
an image recording section; and
a control section, wherein
the control section reads the authentication data from the storage section of the replacement component and executes an authentication process for the replacement component, permits image recording by the image recording section when the authentication process succeeds, and restricts image recording by the image recording section when the authentication process fails,
the storage section includes a free area and a restricted area,
part of the authentication data is stored in the restricted area, and
mirror data having the same content as the authentication data in the restricted area is stored in the free area.

12. A replacement component for an image recording apparatus comprising an image recording section and a control section, comprising:
a storage section that stores authentication data to be read by the control section, the authentication data being data for the control section to execute an authentication process to determine whether to permit or restrict image recording by the image recording section,
wherein
the storage section includes a free area and a restricted area,
part of the authentication data is stored in the restricted area, and
mirror data having the same content as the authentication data in the restricted area is stored in the free area.

13. An ink cartridge comprising:
a liquid chamber storing ink;
a memory including:
an authentication storage area storing an authentication data used for authenticating the ink cartridge;
a first storage area configured to store first data representing the remaining ink amount of the liquid chamber;
a second storage area configured to store second data representing the remaining authentication count using the authentication data; and
a mirror memory area configured to store mirror data of the first data and the second data.

14. The ink cartridge according to claim 13,
wherein the memory further including:
a third storage area configured store third data representing the count of how many times the ink cartridge has been remanufactured,
wherein the mirror memory area configured to store mirror data of the third data.
